(19) United States
(12) Patent Application Publication
(10) Pub. No.: US 2023/0337577 A1
(43) Pub. Date: Oct. 26, 2023

(54) AUTOMATIC OPERATION SYSTEM

(71) Applicant: Positec Power Tools (Suzhou) Co., Ltd., Suzhou (CN)

(72) Inventors: Mingming HE, Suzhou (CN); Yong WANG, Suzhou (CN); Song ZHU, Suzhou (CN)

(21) Appl. No.: 17/791,184

(22) PCT Filed: Jan. 6, 2021
(86) PCT No.: PCT/CN2021/070485

§ 371 Date: Jul. 6, 2022

(30) Foreign Application Priority Data
Jan. 6, 2020 (CN) 202010010480.5
Apr. 24, 2020 (CN) 202010331902.9

(51) Int. Cl. A01D 34/00; G05D 1/02

(52) U.S. Cl. CPC A01D 34/008; A01D 34/001; G05D 1/0246; A01D 2101/00

(57) ABSTRACT

The present invention discloses an automatic operation system. The automatic operation system includes a lawn mower. The lawn mower may include: a housing; a moving module; a cutting module; an energy module, configured to provide energy for the intelligent lawn mower; an image capturing module, configured to capture image information near the intelligent lawn mower, and control movement and/or operation of the intelligent lawn mower according to the captured image information; and a control module, electrically connected to the moving module, the cutting module, and the image capturing module and configured to control the intelligent lawn mower to move and/or operate within an operation region. The intelligent lawn mower includes at least two operation modes, and the image capturing module has at least two operation positions relative to the housing when the intelligent lawn mower operates in the at least two operation modes.

### CROSS-REFERENCE TO RELATED APPLICATION

This application is a National Stage Application of International Application No. PCT/CN2021/070485, filed on Jan. 6, 2021, which claims benefit of and priority to Chinese Patent Application No. 202010010480.5 filed on Jan. 6, 2020, and, No. 202010331902.9 filed on Apr. 24, 2020, all of which are hereby incorporated by reference in their entirety for all purposes as if fully set forth herein.

### TECHNICAL FIELD

The present invention relates to the field of intelligent control, and in particular, to an automatic operation system.

### BACKGROUND

Lawn maintenance requires a lot of manual labor, including constant watering, fertilizing, and mowing the lawn to maintain a healthy grass coverage. Although watering and fertilizing can sometimes be handled with minimal labor by using a sprinkler or a watering system, a mowing process is a process that requires a lot of manual labor of a gardener.

A designer and a manufacturer of a lawn mower has made attempts for some time to manufacture an autonomous lawn mower to replace a conventional push-pull lawn mower. However, due to immaturity of technologies such as identification of an operation region, construction of a map, and planning of a moving path, operation performance of an intelligent lawn mower still remains to be improved.

Therefore, it is necessary to design a new technical solution to resolve the above technical problems.

### SUMMARY

Technical problems are to be solved by the embodiments of present invention. An intelligent lawn mower having an image capturing module at a different operation position is provided.

In order to solve the foregoing problem, the technical solutions of the embodiments of present invention are as follows. An automatic operation system is provided, including an intelligent lawn mower, including:
a housing;
a moving module, configured to drive an intelligent lawn mower to move;
a cutting module, configured to perform cutting;
an energy module, configured to provide energy for the intelligent lawn mower;
an image capturing module, configured to capture image information near the intelligent lawn mower, and control movement and/or operation of the intelligent lawn mower according to the captured image information; and
a control module, electrically connected to the moving module, the cutting module, and the image capturing module and configured to control the intelligent lawn mower to move and/or operate within an operation region.

The intelligent lawn mower includes at least two operation modes. When the intelligent lawn mower operates in the at least two operation modes, the image capturing module has at least two operation positions relative to the housing.

In one of embodiments, the intelligent lawn mower further includes an accommodating cavity arranged at a front end of the housing. The accommodating cavity is configured for the image capturing module to be mounted, the accommodating cavity has a set depth, and the image capturing module is partially or completely accommodated in the accommodating cavity.

In one of embodiments, the intelligent lawn mower includes a first operation mode and a second operation mode. Correspondingly, the image capturing module has a first operation position corresponding to the first operation mode and a second operation position corresponding to the second operation mode and different from the first operation position.

In one of embodiments, the intelligent lawn mower includes an actuating mechanism configured to be connected to the housing and the image capturing module. The control module is configured to control the actuating mechanism to drive the image capturing module to switch between the first operation position and the second operation position.

In one of embodiments, the actuating mechanism includes a lifting unit. The control module is configured to control the lifting unit to drive the image capturing module to ascend and/or descend from the first operation position to the second operation position.

In one of embodiments, the actuating mechanism includes a rotatable unit. The control module is configured to control the rotatable unit to drive the image capturing module to rotate from the first operation position in a vertical direction by a preset angle to the second operation position.

In one of embodiments, when the image capturing module is arranged at the first operation position, an angle between a central axis and a vertical line of the image capturing module ranges from 30 degrees to 60 degrees.

In one of embodiments, when the image capturing module is arranged at the second operation position, an angle between a central axis and a vertical line of the image capturing module ranges from 70 degrees to 110 degrees.

In one of embodiments, the first operation mode includes a mowing mode, and the second operation mode includes a monitoring mode. The intelligent lawn mower identifies a boundary of the operation region and performs the cutting in the mowing mode, and the intelligent lawn mower captures the image information near the intelligent lawn mower in the monitoring mode and determines whether the image information is abnormal. The control module performs switching between the first operation position and the second operation position at least partially according to the switching between the mowing mode and the monitoring mode.

In one of embodiments, the automatic operation system includes a charging station configured to supply power to the intelligent lawn mower. When the intelligent lawn mower returns to the charging station for charging and/or is located at the charging station, the control module controls the intelligent lawn mower to be in the monitoring mode.

In one of embodiments, the operation region includes a preset monitoring position and/or a preset monitoring region and/or a mowing region, and the intelligent lawn mower further includes a state switching mode, where in the state switching mode, the control module controls the intelligent lawn mower to maintain an operation state before switching and to move from a current position to the preset monitoring position and/or the preset monitoring region and/or the mowing region.

In one of embodiments, when the intelligent lawn mower reaches the preset monitoring position and/or the preset monitoring region, the intelligent lawn mower is controlled to switch to the monitoring mode and perform monitoring at the preset monitoring position and/or in the preset monitoring region.

In one of embodiments, when the intelligent lawn mower reaches the mowing region, the intelligent lawn mower is controlled to switch to the mowing mode and perform mowing in the mowing region.

In one of embodiments, when the intelligent lawn mower is in the state switching mode, the control module controls the cutting module to stop the cutting.

In one of embodiments, when the intelligent lawn mower performs switching between the operation modes, the control module controls the intelligent lawn mower to stop moving and/or operating.

In one of embodiments, when the intelligent lawn mower is switched to the monitoring mode or is in the monitoring mode, the control module controls the cutting module to stop the cutting.

Compared with the prior art, the beneficial effects of the technical solution of the embodiments of present invention are as follows. The operation positions of the image capturing module in the intelligent lawn mower in different operation modes are adjusted, that is, the lawn mower respectively has different operation positions in the mowing mode and the monitoring mode, so as to ensure that the intelligent lawn mower can achieve the most efficient operation effect in different operation modes.

### BRIEF DESCRIPTION OF THE DRAWINGS

The foregoing objects, technical solutions, and beneficial effects of the embodiments of present invention can be implemented with reference to the accompanying drawings below:

FIG. 1 is a three-dimensional view of an intelligent lawn mower according to an embodiment of the present invention.

FIG. 2 is a schematic diagram of a sensor installation compartment at a first operation position according to an embodiment of the present invention.

FIG. 3 is a schematic diagram of a sensor installation compartment at a second operation position according to an embodiment of the present invention.

FIG. 4 and FIG. 5 are schematic diagrams of an operation process of an adjustment unit according to an embodiment of the present invention.

FIG. 6 is a schematic diagram of an automatic operation system according to an embodiment of the present invention.

FIG. 7 and FIG. 8 are schematic diagrams of functional modules and a structure of a lawn mower according to an embodiment of the present invention.

FIG. 9 and FIG. 10 are schematic structural diagrams of a lawn mower according to another embodiment of the present invention.

FIG. 11 to FIG. 13 are schematic diagrams of an operation scenario of a lawn mower according to the present invention.

### DETAILED DESCRIPTION

Detailed descriptions and technical content of the embodiments of present invention are described below in cooperation with the accompanying drawings. However, the accompanying drawings only provide reference and description rather than limit the embodiments of present invention.

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the embodiments of present invention.

Unless otherwise defined, meanings of all technical and scientific terms used in this specification are the same as that usually understood by a person skilled in the art to which the present disclosure belongs. In this specification, terms used in the specification of the embodiments of present invention are merely intended to describe objectives of the specific embodiments, but are not intended to limit the embodiments of present invention. In addition, the term “and/or” as used herein includes any and all combinations of one or more related listed items.

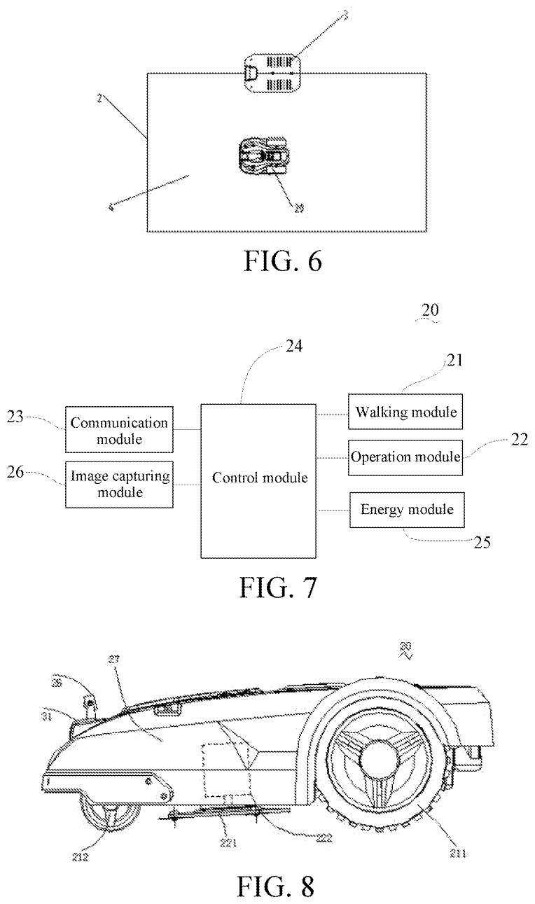

FIG. 6 shows an automatic operation system of this specific implementation. The automatic operation system may include an intelligent lawn mower 20, a boundary 2, and a charging station 3. The intelligent lawn mower 20 moves and operates within a mowing region 4 defined by the boundary 2, and the charging station 3 may be configured to receive docking of the intelligent lawn mower to supplement the intelligent lawn mower with energy in a case that the intelligent lawn mower returns due to insufficient energy.

As shown in FIG. 7 and FIG. 8, the intelligent lawn mower 20 may include a housing 27, and may further include a moving module 21, an operation module 22, a communication module 23, a control module 24, and an energy module 25. The control module 24 is connected to and configured to control the moving module 21 and the operation module 22, so as to realize automatic moving and operation of the intelligent lawn mower 20.

Specifically, the moving module 21 may include a wheel set, which includes a right driving wheel and a left driving wheel, and a moving motor configured to drive the wheel set. Generally, the wheel set includes a driving wheel 211 driven by the moving motor and an auxiliary wheel 212 assisting in supporting the housing. It may be understood that the moving module 21 may also be a track structure. In this embodiment, the right driving wheel and the left driving wheel each are equipped with a driving motor to achieve differential output for steering control. The moving motor may be directly connected to the driving wheel, or a transmission apparatus may be arranged, that is, a same motor drives the right driving wheel and the left driving wheel through different transmission apparatuses, so as to achieve the differential output for steering control. The operation module 22 is a cutting module, such as a cutting blade 221, which may be driven by a cutting motor 222 to operate. A center of the operation module 22 is located on a central axis of the lawn mower 20, is set below the housing and between the auxiliary wheel and the driving wheel, or may be offset to a left side or a right side of the housing. The energy module 25 is fixedly or detachably mounted to the housing, which may be a battery pack, or the like. During operation, the battery pack discharges electric energy to maintain operation and moving of the lawn mower 20. During non-operation, the battery may be connected to an external power supply to be supplemented with electric energy. The intelligent lawn mower 20 may also automatically search for the charging station 3 to be supplemented with electric energy when detecting that the battery is low. The control module 24 may be a controller, which may be configured to control the intelligent lawn mower 20 to move, turn, and automatically operate according to a preset program or a received instruction. The communication module 23 may include, but is not limited to, at least one of the following: a Wi-Fi module, a Bluetooth module, an infrared module, or a cellular communication module such as a 4G or 5G module.

The automatic operation system may include a navigation mechanism, which may include but is not limited to at least one of the following: a UWB sensor, an inertial navigation device, a satellite navigation system (GPS, Beidou, RTK, and the like), or an image capturing module 26 (also referred to as a visual sensor or a camera in this application). When the image capturing module configured to identify a boundary is arranged on the lawn mower, the lawn mower may operate in an operation region in a manner of a random move, and identifies the boundary by using the image capturing module 26, to ensure safety of the lawn mower. Alternatively, navigation may be realized through a combination of a low-precision satellite navigation system and the image capturing module 26, that is, a combination of a low-precision GPS and a visual sensor.

In an embodiment of this application, the automatic operation system includes the image capturing module 26 configured to identify the boundary. The image capturing module may be configured to assist in the mowing and monitoring. The operation region may include a mowing region and a monitoring region. The two regions may overlap each other. During mowing of the lawn, the lawn mower cuts grass in the mowing region, and the image capturing module may be configured to identify the boundary of the operation region. During monitoring, the lawn mower performs monitoring in the monitoring region, and the image capturing module may capture image information nearby to determine whether the captured image information is abnormal. If an abnormality exists, the image capturing module sounds the alarm or sends a notification message to a user.

The intelligent lawn mower identifies the boundary of the operation region by using the visual sensor, to control the intelligent lawn mower to normally move within the boundary, thereby ensuring the safety of the lawn mower in the operation process. In this application, the intelligent lawn mower may also monitor the external environment by using the visual sensor, to prevent the lawn mower from being stolen, thereby ensuring safety of the user. Certainly, the lawn mower may also include other operation modes such as mapping, which is not limited in this application. Generally, when the boundary is identified, a field of view of the visual sensor is inclined downward, so that the intelligent lawn mower can efficiently identify the boundary between grass and non-grass or a short obstacle, to prevent occurrence of an unsafe phenomenon such as going out of bounds. During the monitoring, the field of view of the visual sensor is generally parallel to or inclined upward from the ground, so as to efficiently monitor the vicinity of the lawn mower.

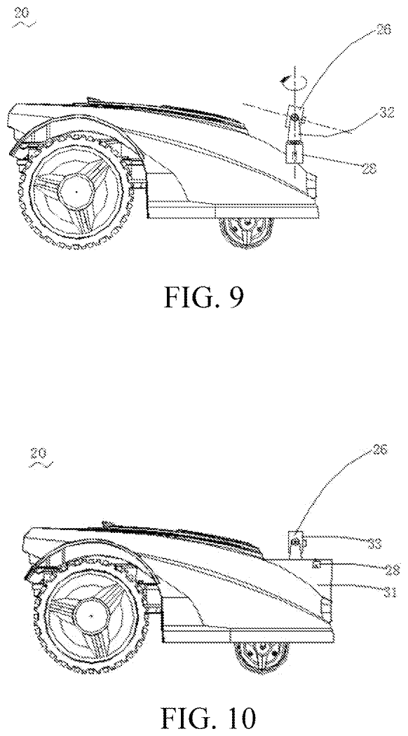

Considering that during the monitoring by using the intelligent lawn mower mounted with the visual sensor, if the field of view during identification of the boundary is used, the lawn mower is not be able to observe a distant object in advance, and a monitoring effect becomes poor. In this application, an intelligent lawn mower is provided. An image capturing module is mounted on the intelligent lawn mower, and is configured to capture image information near the intelligent lawn mower, and control movement and/or operation of the intelligent lawn mower according to the captured image information. The intelligent lawn mower includes at least two operation modes. When the intelligent lawn mower operates in the at least two operation modes, the image capturing module has at least two operation positions relative to the housing. Specifically, the lawn mower may include two operation modes: a mowing mode and a monitoring mode. Correspondingly, the image capturing module has a first operation position in the mowing mode, which is generally inclined downward from the ground. That is, an angle between a center line (or a central axis) of the field of view of the image capturing module and a vertical line ranges from 30 degrees to 60 degrees, which is shown by two dotted lines in FIG. 9. The image capturing module has a second operation position in the monitoring mode, which is generally parallel to or inclined upward from the ground. That is, an angle between a center line (or the central axis) of the field of view of the visual sensor and the vertical line ranges from 70 degrees to 110 degrees. The lawn mower is adjusted to a corresponding operation position in different operation modes, and therefore has a better operation effect in different operation modes.

In an embodiment of this application, the intelligent lawn mower may further include an actuating mechanism, configured to be connected to the housing and the image capturing module. The control module is configured to control the actuating mechanism to drive the image capturing module to switch between the first operation position and the second operation position. That is, when the lawn mower switches the operation mode, the lawn mower is adjusted to the corresponding operation position through the actuating mechanism.

In an embodiment of this application, the actuating mechanism may include a lifting unit 32. The control module is configured to control the lifting unit 32 to drive the image capturing module to ascend and/or descend from the first operation position to the second operation position, which may be realized through a lifting cylinder. As shown in the schematic diagram of the lawn mower in the mowing mode in FIG. 9, when the lawn mower switches to the monitoring mode, a camera may be controlled to descend to the second operation position.

In another embodiment of this application, the actuating mechanism may further include a rotatable unit 33. The control module controls the rotatable unit 33 to drive the image capturing module to rotate from the first operation position in a vertical direction by a preset angle to the second operation position, which may be realized by driving a rotary shaft by a motor 28. When the lawn mower shown in FIG. 9 is switched to the monitoring mode shown in FIG. 10, the rotatable unit 33 may be controlled to rotate upward by a preset angle in the vertical direction to reach the second operation position. When the lawn mower is in the mowing mode, the image capturing module is at a higher position relative to the housing, and an angle between the image capturing module and a horizontal plane is relatively small, which is convenient for the image capturing module to identify the boundary and the short obstacle as soon as possible. When the lawn mower is in the monitoring mode, the image capturing module is at a lower position relative to the housing, and an angle between the image capturing module and the horizontal plane is relatively large, which is convenient for the image capturing module to identify other target objects such as a person as soon as possible.

In an embodiment, as shown in FIG. 8, the intelligent lawn mower may further include an accommodating cavity 31 arranged at a front end of the housing. The accommodating cavity is configured for the image capturing module to be mounted, the accommodating cavity has a set depth, and the image capturing module is partially or completely accommodated in the accommodating cavity. Further, a shielding cover is further arranged on the housing, and is configured to shield the accommodating cavity. When the lawn mower stops operating and moves in other operation modes that require no camera through satellite navigation, the camera may be received in the accommodating cavity manually through a button arranged on the housing or through remote control of a mobile phone, so that the camera can be protected and the service life of the camera can be prolonged.

In an embodiment of this application, the lawn mower may be switched between the mowing mode and the monitoring mode according to the received instruction from the user, a mowing schedule, and a monitoring schedule. Specifically, when the lawn mower is in the mowing mode, if a control instruction to switch to the monitoring mode sent by the user is received, the control module may control the lawn mower to switch to the monitoring mode, and vice versa. Alternatively, when a machine leaves a factory, the lawn mower may be set to be in the mowing mode from 10:00 a.m. to 5:00 p.m. on weekdays and to be in the monitoring mode from 6:00 p.m. to 10:00 p.m. on weekdays. If a current time is 11 a.m. on Thursday, the lawn mower is in the mowing mode. If the current time is 8 p.m. on Thursday, the lawn mower is in the monitoring mode.

In another embodiment of this application, the lawn mower is in the monitoring mode when the lawn mower returns to or at the charging station for charging. Specifically, when a low battery is detected during the mowing, the control module may control the lawn mower to switch from the mowing mode to the monitoring mode and to move to the charging station under guidance of GPS and a magnetic strip, and perform the monitoring during the charging. Alternatively, when a low battery is detected during the mowing, the control module may control the lawn mower to return to the charging station. During charging of the lawn mower after arriving at the charging station, the control module controls the lawn mower to switch to the monitoring mode. When the lawn mower is fully charged, the control module controls the lawn mower to enter the mowing mode again and to move from the charging station to the operation region where the mowing is performed to perform the mowing. The user may arrange the charging station at a position that is required to be monitored, such as near a door of a house, so that the lawn mower can be monitored at the charging station.

In one embodiment of this application, the intelligent lawn mower further includes a state switching mode. In the state switching mode, the control module controls the image capturing module to maintain an operation position before switching, and controls the lawn mower to move from a current position to the preset monitoring position and/or the preset monitoring region and/or the mowing region. When an initial state of the lawn mower is the mowing mode and is required to be switched to the monitoring mode, only when the lawn mower reaches the preset monitoring position and/or the preset monitoring region, the lawn mower is controlled to switch to the monitoring mode, and is controlled to perform the monitoring at the preset monitoring position and/or in the preset monitoring region. In this case, the cutting module stops the cutting. Before the lawn mower reaches the monitoring region, the image capturing module maintains the operation position before switching and identifies the boundary through the image capturing module, to prevent an unsafe event such as going out of bounds. When the initial state of the lawn mower is the monitoring mode and is required to switch to the mowing mode, the lawn mower is controlled to switch to the mowing mode and to perform the mowing in the mowing region when the lawn mower reaches the mowing region. In this embodiment of this application, when the lawn mower is switched to the monitoring mode, the visual sensor is adjusted to the second operation position with a higher field of view. However, when the lawn mower has the higher field of view, the lawn mower cannot normally identify the boundary, a small animal, and the short obstacle, which may cause harm to a pedestrian or the small animal during the moving. Therefore, the lawn mower may be controlled to switch the operation mode after receiving a switching instruction and moving to the corresponding operation region. For example, monitoring is continuously performed after the lawn mower reaches a preset monitoring position or a preset monitoring region, to ensure safety of the lawn mower itself and the small animal.

In another embodiment of this application, the lawn mower may also be immediately switched to the corresponding operation mode when receiving the switching instruction, and moves to the corresponding region in the operation mode. The initial state of the lawn mower is the mowing mode. The lawn mower is immediately switched to the monitoring mode when receiving the instruction to switch to the monitoring mode, the position of the visual sensor is adjusted to the second operation position, and the lawn mower is guided to the preset monitoring position in a navigation mode such as GPS. When the lawn mower reaches the preset monitoring position and/or the preset monitoring region, the monitoring is performed at the position or in the region.

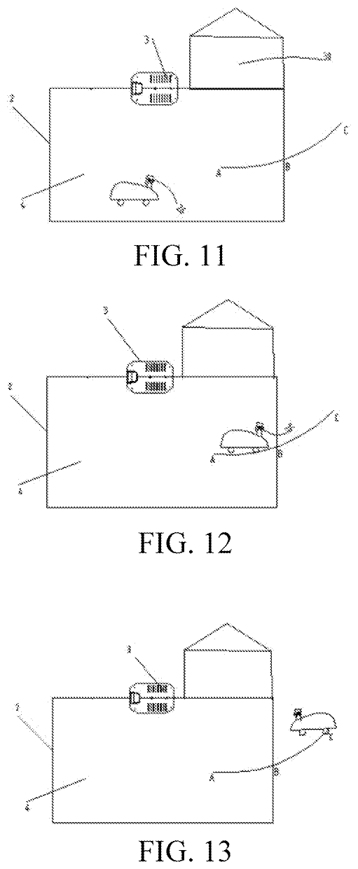

In an operation scenario of the automatic operation system shown in FIG. 11 to FIG. 13, except for the boundary 2, a magnetic apparatus (for example a magnetic strip and an encoded magnetic strip) is arranged in the operation region by using a position A as a starting point and a position C as an end point. A visual beacon is set at or near the position A, and the visual sensor may identify the current position according to the collected beacon. Similarly, the visual beacon is also set at or near the position C. A line connecting A to C may also be a barcode (for example, a QR code), and the visual sensor determines the current position by identifying the QR code. Alternatively, a region may be laid by using the magnetic strip, so that the lawn mower can identify the QR code in the monitoring mode to complete path guidance in the region.

In this application scenario, the visual beacon arranged at the position A and the position C is used as an example. As shown in FIG. 11, the lawn mower is in the mowing mode, and the visual sensor mounted on the lawn mower is at the first operation position (for example, an angle between a central axis of a field of view of a visual sensor and a vertical line is 40 degrees). When the lawn mower receives an instruction to switch to the monitoring mode, the control module controls the lawn mower to enter the state switching mode, maintains the lawn mower in the mowing mode that identifies the boundary, and stops moving and/or mowing. Beacons at the position A and the position C are stored in the lawn mower. In the monitoring mode, the lawn mower moves near the magnetic strip and determines the current position according to the identified visual beacon. When the lawn mower reaches the position A shown in FIG. 12, the lawn mower is controlled to move along the magnetic strip to the position C shown in FIG. 13. After the lawn mower reaches the position C, the control module controls the lawn mower to switch to the monitoring mode, and controls the visual sensor to rotate upward by a predetermined angle in the vertical direction to reach the second operation position (for example, the angle between the central axis of the field of view of the visual sensor and the vertical line is 110 degrees). The vicinity of the lawn mower is monitored at the position C. The cutting module always maintains the state of stopping cutting during the monitoring. On the contrary, when the lawn mower is in the monitoring mode, and when an instruction to switch to the mowing mode is received, the control module controls the lawn mower to stop moving and operating. The lawn mower is controlled to move along the magnetic strip from the position C to the position A, and after the lawn mower reaches the position A, the control module controls the visual sensor to rotate upward by the predetermined angle of 40 degrees in the vertical direction, and controls a mowing module to start mowing. That is, when the lawn mower is switched from the monitoring mode to the mowing mode, the lawn mower may perform the mowing only when the lawn mower reaches the operation region where the mowing can be performed. Through the above method, the lawn mower does not harm the pedestrian and the animal in the monitoring mode, so as to ensure the safety of the lawn mower. Further, the visual beacon may also be set at an intersection of the magnetic strip and the boundary, that is, at the position B. The lawn mower starts mowing when reaching the position B.

In an embodiment of this application, a distance detection module is mounted to the lawn mower and is configured to detect a distance between the user and the lawn mower when the lawn mower does not reach the corresponding operation position (such as the position A or the position C in the above embodiment) during the mode switching. Specifically, the distance detection module may be a communication module, and determines the distance between the user and the lawn mower depending on whether a signal is received or according to a strength of the received signal. The distance detection module may be a near field communication module, such as a Bluetooth module, an NFC module, and the like. When it is detected that the distance between the user and the lawn mower is less than or equal to a preset distance, an alarm may be sounded or a notification message related to safety reminders may be sent to the client. In this embodiment, the distance between the user and the lawn mower is controlled to ensure that the user is always near the lawn mower during the mode switching of the lawn mower, so as to ensure the safety of the lawn mower and the pedestrian and the animal nearby.

In another embodiment of this application, the lawn mower may also build a map of the entire operation region by using low-precision GPS, and capture the image information by using the image capturing module during the operation or moving of the lawn mower. The operation region includes three parts: an operation region where only the mowing mode is executed, an operation region where only the monitoring mode is executed, and an operation region where both the mowing mode and the monitoring mode can be executed. In an embodiment of this application, when the lawn mower is required to switch the operation mode, the lawn mower may be controlled to move to the corresponding operation region, and switch to the operation mode such as the mowing mode or the monitoring mode after reaching the corresponding operation region for the mowing or the monitoring, thereby ensuring the safety and efficient operation of the lawn mower.

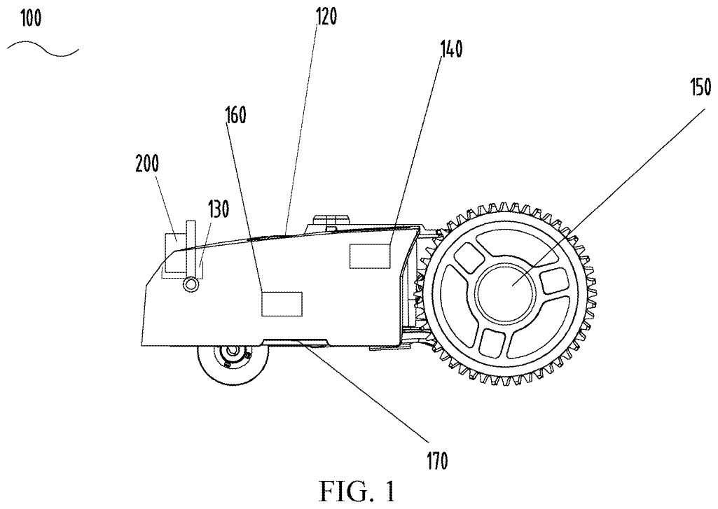

FIG. 1 shows a three-dimensional view of an intelligent lawn mower 100 according to an embodiment of the present invention. The intelligent lawn mower 100 can move and operate within an operation region defined by a boundary, and includes: a housing 120; a moving module 150, configured to drive the intelligent lawn mower 100 to move; a cutting module 170, configured to perform cutting of the intelligent lawn mower 100; an energy module 140, configured to provide energy for the intelligent lawn mower 100 for the intelligent lawn mower 100 to move and operate, where specifically, the energy module 140 includes a battery pack, and when the energy stored in the energy module 140 is insufficient, the intelligent lawn mower 100 can return to a docking station to be supplemented with energy, and leave the charging station after the charging is completed; and a control module 160, electrically connected to the moving module 150 and the cutting module 170 and configured to control the movement and the operation of the intelligent lawn mower 100, where specifically, the control module 160 can control the intelligent lawn mower 100 to perform different movement and operation strategies according to different scenarios. Specifically, the operation region of the intelligent lawn mower 100 is defined by the boundary. The common boundary includes a boundary line that generates a magnetic field in response to an applied current, a boundary label that can identify information, and a virtual boundary composed of a plurality of pieces of boundary positioning data. The intelligent lawn mower 100 includes various types of sensors corresponding to the operation region to identify various boundary types in different scenarios. For example, a magnetic sensor identifies a magnetic field region to determine the operation region, the visual sensor identifies a boundary pattern to determine the operation region, or current positioning information of the intelligent lawn mower is acquired and compared with the boundary position information to determine that the intelligent lawn mower is inside the operation region. The intelligent lawn mower 100 may plan a moving path according to preset moving logic when moving in the operation region, and continuously detect different information in the operation region during the moving to determine whether the moving path is required to be adjusted in time. For example, an avoidance measure is taken when the obstacle is encountered. Therefore, the intelligent lawn mower 100 is required to carry a plurality of sensors to adapt to a complex operation condition of the operation region. In this embodiment, the intelligent lawn mower 100 further includes a sensor installation compartment 130 arranged on the housing 120. The sensor installation compartment may be configured for a sensor module 200 to be mounted, and the intelligent lawn mower 100 may match a plurality of different sensor modules 200 to realize different identification functions, which affects the movement and operation strategy of the intelligent lawn mower 100. Specifically, the sensor module 200 may include the visual sensor configured to visually identify grass quality, a shadow region, and an obstacle in the operation region. The sensor module may include an ultrasonic sensor, configured to transmit an ultrasonic signal and receive an echo signal to determine whether the intelligent lawn mower 100 encounters the obstacle and perform an avoidance function when it is determined that the obstacle is encountered. The sensor module further includes other similar sensors configured to identify the operation region. These sensors can identify a specific operation condition in the operation region, and perform a corresponding action according to a processing logic preset by the intelligent lawn mower 100. The sensor installation compartment 130 is configured to have a first operation position and a second operation position different from the first operation position.

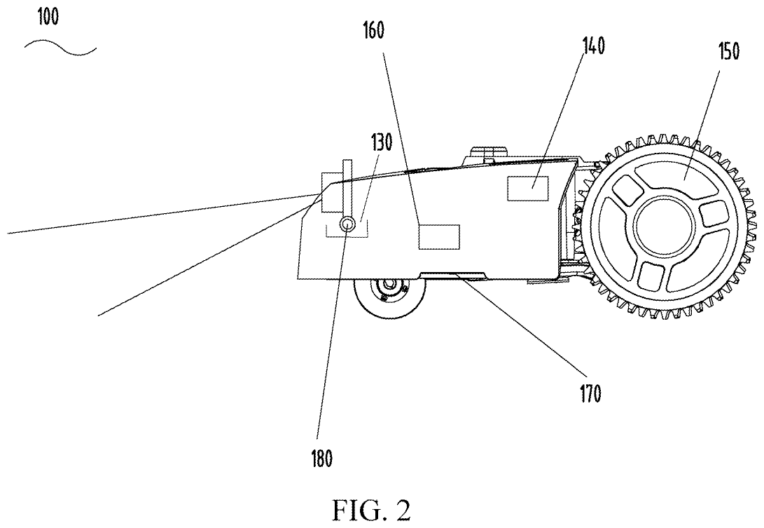

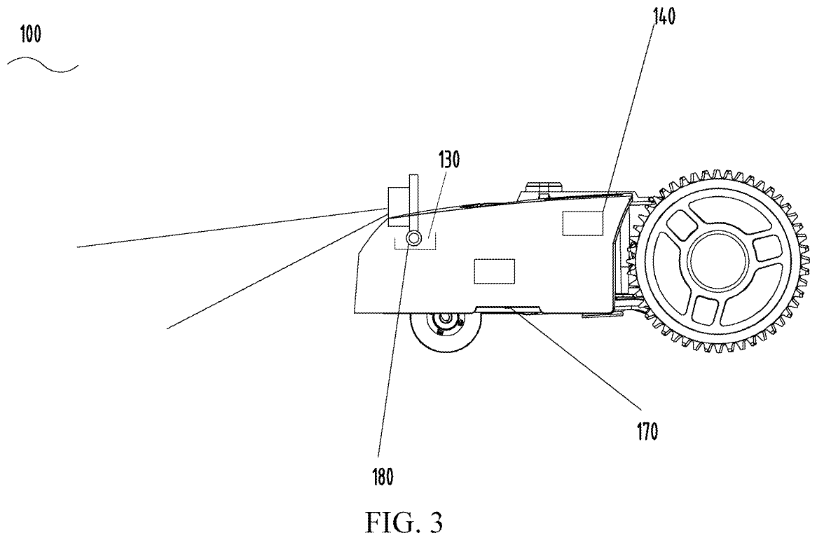

Referring to FIG. 2 and FIG. 3, FIG. 2 and FIG. 3 are schematic diagrams of the sensor installation compartment 130 at the first operation position and the second operation position according to an embodiment of the present invention. The intelligent lawn mower 100 includes the sensor installation compartment 130, and the user may select a different sensor module 200 for the intelligent lawn mower 100 according to their own requirements and mount the sensor module in the sensor installation compartment 130. Specifically, the sensor installation compartment 130 has an interface, through which the sensor module 200 is detachably mounted to the sensor installation compartment 130. Specifically, the sensor module 200 may be electrically connected to the control module 160 of the intelligent lawn mower 100, and detection information of the sensor module 200 is transmitted to the control module 160, and the control module 160 processes and executes the corresponding control strategy. In this embodiment, the sensor module 200 is described with the visual sensor. It should be noted that, in other embodiments, various different types of sensor modules 200 may be mounted on the intelligent lawn mower 100 to satisfy diversified requirements of the intelligent lawn mower 100. The visual sensor includes an image capturing unit, usually a camera, which can capture image information in the operation region, and process the image information and extract useful information to adjust the moving strategy, the cutting strategy, and the like of the intelligent lawn mower 100 according to the information. Specifically, in this embodiment, the intelligent lawn mower 100 includes a positioning module (not shown). The intelligent lawn mower 100 can acquire satellite positioning information through the positioning module, such as GPS, GNSS, a Beidou satellite, and the like. The intelligent lawn mower 100 determines the operation boundary of the intelligent lawn mower 100 through the positioning information, and the intelligent lawn mower 100 is controlled to move and operate within the operation region after the boundary is determined. In addition, the intelligent lawn mower 100 may determine an operation map of the operation region through the positioning module, for example, determine where an island region is located or where a poorly located shadow region is located, and the intelligent lawn mower 100 accordingly generates the map of the operation region and controls the movement and cutting strategy of the intelligent lawn mower 100. Specifically, an operation condition in the operation region is required to be confirmed, and the map is built according to the operation condition, or the map is updated after the map is built. The visual sensor may be configured to identify environmental information in the operation region. For example, after a flower bed is identified, the flower bed is determined as a region that does not require operation, and a region having insufficient light is identified as a region with low cutting frequency. Such information is updated into the operation region map, which facilitates more accurate and more efficient cutting by the intelligent lawn mower 100. Therefore, the visual sensor arranged for the intelligent lawn mower 100 can effectively improve an operation effect and use experience of the intelligent lawn mower 100.

When the intelligent lawn mower 100 performs the operation in the operation region, the obstacle may exist in the operation region, such as a large rock, a small animal, and the like, and the intelligent lawn mower 100 is required to avoid these obstacles to perform the operation. Generally, the intelligent lawn mower 100 is equipped with a collision detection sensor, such as a Hall sensor, and executes the avoidance strategy when a collision is detected, so as to avoid affecting normal operation of the intelligent lawn mower 100 after encountering the obstacle. In some cases, the intelligent lawn mower 100 may be equipped with the visual sensor. The visual sensor detects an image in the operation region. It may be determined by processing these images whether the intelligent lawn mower 100 encounters the obstacle, and the avoidance strategy is executed after it is determined that the obstacle is encountered. The identification of the obstacle by the visual sensor is more accurate. Different obstacle avoidance strategies may be executed for different types of obstacles. Moreover, the identification of the obstacle by the visual sensor can realize non-contact obstacle avoidance, so that the intelligent lawn mower 100 can detect the obstacle as early as possible and execute the avoidance strategy. When the intelligent lawn mower 100 requires the visual sensor to assist mapping, the visual sensor identifies a condition of a surface of the operation region, so as to identify a preset scenario and cause the intelligent lawn mower 100 to perform a corresponding control action. When the intelligent lawn mower 100 requires the visual sensor to identify the obstacle in the operation region, the intelligent lawn mower 100 identifies whether an obstacle exists ahead in a direction of advance, so as to control execution of a corresponding avoidance behavior. Specifically, referring to FIG. 1, when the visual sensor performs the identification of the surface of the operation region, the sensor installation compartment 130 is at the first operation position. Referring to FIG. 2, when the visual sensor performs the identification in the direction of advance of the intelligent lawn mower 100, the sensor installation compartment 130 is at the second operation position.

The sensor installation compartment 130 has a first operation position and a second operation position, and the first operation position and the second operation position have different heights. Specifically, during identification of the surface of the operation region, that is, when the intelligent lawn mower 100 identifies the condition of the surface of the operation region to assist the mapping, the visual sensor is at a lower position relative to the housing 120 is relatively low, so that the field of view of the visual sensor mainly covers the surface of the operation region. During identification of an object ahead in the direction of advance of the intelligent lawn mower 100, the visual sensor is at a higher position relative to the housing 120. The sensor installation compartment 130 is arranged to have the first operation position and the second operation position, so that the sensor module 200 mounted therein have different operation positions. A different position has a different field of view. Therefore, usage requirements in different scenarios can be satisfied, and a plurality of sets of sensor modules 200 are not required to be mounted simultaneously to satisfy the usage requirements for the different scenarios of the sensor modules. In this embodiment, when the sensor installation compartment 130 is at the first operation position, the sensor installation compartment 130 is at a lower position relative to the housing 120, and the visual sensor mounted therein is configured to identify information on the surface of the operation region. When the sensor installation compartment 130 is at the second operation position, the sensor installation compartment 130 is at a higher position relative to the housing 120, and the visual sensor mounted therein is configured to identify the object in the direction of advance of the intelligent lawn mower 100.

In this embodiment, the sensor installation compartment 130 has a first operation position and a second operation position. An angle of rotation exists between the first operation position and the second operation position in a horizontal direction. Specifically, when the sensor module 200 is mounted in the sensor installation compartment 130, for example, when the visual sensor is mounted therein, the sensor installation compartment 130 is arranged to be rotatable in the horizontal direction to have the first operation position and the second operation position, so that the visual sensor has a larger field of view.

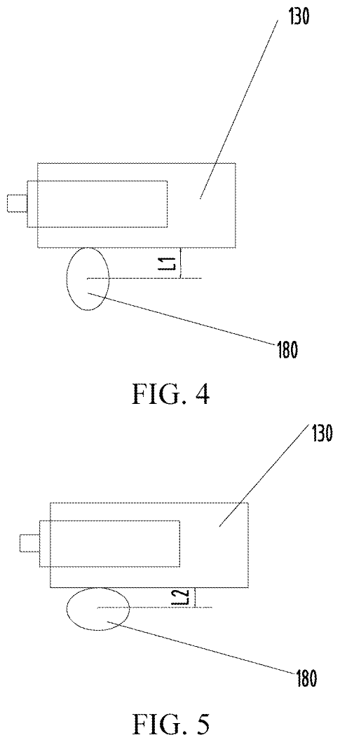

The intelligent lawn mower 100 includes an adjustment unit 180. The adjustment unit 180 is connected to the sensor installation compartment 130. The position of the sensor installation compartment 130 is adjusted by the adjustment unit 180 so that the sensor installation compartment 130 is at the first operation position or the second operation position. Referring to FIG. 4 and FIG. 5, specifically, the adjustment unit 180 includes a cam mechanism. The cam mechanism has a short-range axial surface and a long-range axial surface, and the cam mechanism rotates so that the short-range axial surface or the long-range axial surface contacts the sensor installation compartment 130. When the short-range axial surface contacts the sensor installation compartment 130, the sensor installation compartment 130 has the first operation position. In this case, the sensor installation compartment 130 is at a lower position relative to the housing 120. When the long-range axial surface contacts the sensor installation compartment 130, the sensor installation compartment 130 is at the second operation position. In this case, the sensor installation compartment 130 is at a higher position relative to the housing 120. Specifically, the intelligent lawn mower 100 includes a manipulating element. The manipulating element is connected to the cam mechanism. The user may rotate the cam mechanism by operating the manipulating element, so as to adjust the position of the sensor installation compartment 130. In other embodiments, the adjustment element includes an electric motor. When the operation position of the sensor installation compartment 130 is required to be changed, the control module 160 generates control information, and the electric motor rotates to adjust the position of the sensor installation compartment 130.

In another embodiment, the intelligent lawn mower 100 can automatically switch the first operation position and the second operation position of the sensor installation compartment 130. Specifically, the intelligent lawn mower 100 has a mapping mode. In the mapping mode, the intelligent lawn mower 100 moves in the operation region and builds a map of the operation region. Upon completion of mapping, the intelligent lawn mower 100 moves and operates in the operation region. Specifically, the intelligent lawn mower 100 has an operation mode, and the intelligent lawn mower 100 moves in the operation region after completing the mapping to perform operation. Upon completion of the mapping mode, the intelligent lawn mower 100 switches to the operation mode to perform the operation, and the sensor installation compartment 130 switches the first operation position and the second operation position at least partially according to the switching of the mapping mode and the operation mode of the intelligent lawn mower 100. Specifically, in the mapping mode, the sensor installation compartment 130 is located at the first operation position. In this case, the sensor installation compartment 130 is at a lower position relative to the housing 120. Upon completion of the mapping, the sensor installation compartment 130 is at the second operation position. In this case, the sensor installation compartment 130 is at a higher position relative to the housing 120. The sensor installation compartment 130 is at the second operation position by default to identify the object in the operation region and avoid the obstacle. When the mapping mode is required to be enabled, or when the operation mode is required to be started upon completion of the mapping mode, the control module 160 sends the control information to the sensor installation compartment 130 to realize automatic switching between the first operation position and the second operation position. In another embodiment, the intelligent lawn mower 100 can switch the first operation position and the second operation position of the sensor installation compartment 130 in response to receiving of the control information from the user. Specifically, the user may send an instruction by using a remote device such as a smart phone or a mobile computer, so that the position of the sensor installation compartment 130 performs a corresponding action according to the instruction.

The technical features in the above embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the present disclosure, and their description is specific and detailed, but cannot therefore be understood as a limitation to the patent scope of embodiments of the present invention. It should be noted that a person of ordinary skill in the art may further make several variations and improvements without departing from the concept of embodiments of the present invention, and these variations and improvements all fall within the protection scope of embodiments of the present invention. Therefore, the protection scope of the patent of embodiments of the present invention shall be topic to the appended claims.

What is claimed is:

1. An automatic operation system, comprising an intelligent lawn mower, the intelligent lawn mower comprising:
a housing;
a moving module, configured to drive the intelligent lawn mower to move;
a cutting module, configured to perform cutting;
an energy module, configured to provide energy for the intelligent lawn mower;
an image capturing module, configured to capture image information near the intelligent lawn mower, and control movement and/or operation of the intelligent lawn mower according to the captured image information; and
a control module, electrically connected to the moving module, the cutting module, and the image capturing module and configured to control the intelligent lawn mower to move and/or operate within an operation region,
wherein the intelligent lawn mower comprises at least two operation modes, and when the intelligent lawn mower operates in the at least two operation modes, the image capturing module has at least two operation positions relative to the housing.

2. The automatic operation system according to claim 1, wherein the intelligent lawn mower further comprises an accommodating cavity arranged at a front end of the housing, the accommodating cavity is configured for the image capturing module to be mounted, the accommodating cavity has a set depth, and the image capturing module is partially or completely accommodated in the accommodating cavity.

3. The automatic operation system according to claim 1, wherein the intelligent lawn mower comprises a first operation mode and a second operation mode, and correspondingly, the image capturing module has a first operation position corresponding to the first operation mode and a second operation position corresponding to the second operation mode and different from the first operation position.

4. The automatic operation system according to claim 3, wherein the intelligent lawn mower comprises an actuating mechanism configured to be connected to the housing and the image capturing module, and the control module is configured to control the actuating mechanism to drive the image capturing module to switch between the first operation position and the second operation position.

5. The automatic operation system according to claim 4, wherein the actuating mechanism comprises a lifting unit, wherein the control module is configured to control the lifting unit to drive the image capturing module to ascend and/or descend from the first operation position to the second operation position.

6. The automatic operation system according to claim 4, wherein the actuating mechanism comprises a rotatable unit, and the control module is configured to control the rotatable unit to drive the image capturing module to rotate from the first operation position in a vertical direction by a preset angle to the second operation position.

7. The automatic operation system according to claim 6, wherein when the image capturing module is arranged at the first operation position, an angle between a central axis and a vertical line of the image capturing module ranges from 30 degrees to 60 degrees.

8. The automatic operation system according to claim 6, wherein when the image capturing module is arranged at the second operation position, an angle between a central axis and a vertical line of the image capturing module ranges from 70 degrees to 110 degrees.

9. The automatic operation system according to claim 3, wherein the first operation mode comprises a mowing mode, and the second operation mode comprises a monitoring mode, wherein the intelligent lawn mower identifies a boundary of the operation region and performs the cutting in the mowing mode, the intelligent lawn mower captures the image information near the intelligent lawn mower in the monitoring mode and determines whether the image information is abnormal, and the control module performs switching between the first operation position and the second operation position at least partially according to the switching between the mowing mode and the monitoring mode.

10. The automatic operation system according to claim 9, comprising a charging station configured to supply power to the intelligent lawn mower, wherein when the intelligent lawn mower returns to the charging station for charging and/or is located at the charging station, the control module controls the intelligent lawn mower to be in the monitoring mode.

11. The automatic operation system according to claim 9, wherein the operation region comprises a preset monitoring position and/or a preset monitoring region and/or a mowing region, and the intelligent lawn mower further comprises a state switching mode, wherein in the state switching mode, the control module controls the intelligent lawn mower to maintain an operation state before switching and to move from a current position to the preset monitoring position and/or the preset monitoring region and/or the mowing region.

12. The automatic operation system according to claim 11, wherein when the intelligent lawn mower reaches the preset monitoring position and/or the preset monitoring region, the intelligent lawn mower is controlled to switch to the monitoring mode and perform monitoring at the preset monitoring position and/or in the preset monitoring region.

13. The automatic operation system according to claim 11, wherein when the intelligent lawn mower reaches the mowing region, the intelligent lawn mower is controlled to switch to the mowing mode and perform mowing in the mowing region.

14. The automatic operation system according to claim 11, wherein when the intelligent lawn mower is in the state switching mode, the control module controls the cutting module to stop the cutting.

15. The automatic operation system according to claim 9, wherein when the intelligent lawn mower performs switching between the operation modes, the control module controls the intelligent lawn mower to stop moving and/or operating.

16. The automatic operation system according to claim 9, wherein when the intelligent lawn mower is switched to the monitoring mode or is in the monitoring mode, the control module controls the cutting module to stop the cutting.
